(19) United States
(12) Patent Application Publication
(10) Pub. No.: US 2020/0226687 A1
(43) Pub. Date: Jul. 16, 2020

(54) SYSTEMS AND METHODS FOR LIQUIDITY TRANSFER

(71) Applicant: Mercury Digital Assets Exchange, Inc., Atlanta, GA (US)

(72) Inventor: Achuthan Krishna, Atlanta, GA (US)

(73) Assignee: Mercury Digital Assets Exchange, Inc., Atlanta, GA (US)

(21) Appl. No.: 16/739,410

(22) Filed: Jan. 10, 2020

Related U.S. Application Data
(60) Provisional application No. 62/790,650, filed on Jan. 10, 2019.

(51) Int. Cl. G06Q 40/06; H04L 9/06

(52) U.S. Cl. CPC G06Q 40/06; H04L 2209/38; H04L 2209/56; H04L 9/0643

(57) ABSTRACT

A platform providing an electronic currency exchange is provided. The electronic exchange of assets is provided, wherein exchange of fiat currency, cryptocurrency, tokenized assets, or a combination thereof is realized. The liquid transfer of assets is realized through the conversion of a first asset into a second asset wherein the first asset is first converted, or sold, onto a tokenized asset which is then converted into the second asset. An asset exchange framework provides a platform for the liquid transfer of assets through asset matching based on specific user instruction and true intention.

### CROSS REFERENCE TO RELATED APPLICATIONS

This application claims the benefit of U.S. Provisional Application No. 62/790,650 filed on Jan. 10, 2019, the contents of which are incorporated by reference herein.

### FIELD OF THE INVENTION

The present invention relates to the electronic transfer of assets, and, more particularly, improving overall liquidity of a system, reducing leg risk for customers, and enabling better prices and tightening of a market.

### BACKGROUND

With the advance of technology and spread of Internet access, the world is becoming more connected and people have access to nearly any information they seek. The number of internet users has been growing exponentially. Today, over 3.8 billion people has internet access, which is over 50% of the world's population, and this number is expected to rise. Over the past 20 years, the creation and usage of websites has been expanding with widespread access to the internet. The number of websites totaled 1 million in 1997, then reached and maintained at a milestone of 1 billion since 2016.

Another growing trend in the digital world is the development of decentralized trust utilizing what has been termed a blockchain. In its simplest form, blockchain is a data structure on which transactional data which are highly resistant to modification may be stored. Blockchain technology at its core makes use of the Merkle tree data structure in combination with cryptographic technology. As a data structure, blockchain is a form of distributed ledger technology that enables data sharing across a network of individual computers. Benefits to blockchain technology include: i) that all of the data and transactions that are on the blockchain are difficult to modify or hack; and ii) that the data itself is transparent. Utilizing blockchain technology, payments and/or contracts may be performed by distributed consensus and recorded on a blockchain. Blockchain technology provides a way to transfer data that is immutable, transparent, auditable, and resistant to failures. Blockchain technologies allow parties transact business without necessarily trusting each other. The decentralized nature of the blockchain makes it more democratic, secured, and transparent. Digital coins, such as Bitcoin (BTC) or Ether (ETH), are much more than a digital currency, but a network of trust that provides the basis for so much more than just currencies. Cryptocurrency, such as BTC or ETH, is a collection of concepts and technologies that form the basis of a digital money ecosystem. Units of currency, such as BTC or ETH, are used to store and transmit value among, users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake).

Blockchain based crypto-currencies are highly immune to attacks owing to the strong encryptions used for securing the data. However, the same cannot be said about the systems and communication channels that store and transport the tokens, especially the encryption/decryption keys, resulting in frequent attacks and theft of crypto-currency tokens. Securing the systems like crypto-currency exchanges cannot be done by hiding the details of the security framework or through obfuscation.

### SUMMARY OF THE INVENTION

In accordance with at least one embodiment of the disclosed invention, a method is disclosed for the computer-implemented trade, transfer, and/or exchange of assets. Assets may include, but is not limited to, digital assets, digital currencies, fiat currencies, crypto-currencies, and/or the derivatives of such instruments, such as futures/options/swaps, etc. Further assets may include tokenized assets, such as tokenized gold, tokenized oil, tokenized gas, tokenized securities, tokenized fiat currencies, stable currencies, tokenized services, utility tokens, or the like. Embodiments disclosed herein account for no implicit movement of currencies and the ability for individuals to express their true intention while eliminating, or severely decreasing, leg risk.

In another embodiment of the disclosed invention, the disclosed embodiments provide a framework in the form of an asset exchange. An asset exchange framework provides a platform for the liquid transfer of assets through asset matching based on specific user instruction and true intention.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a simplified functional block diagram of a computer system in accordance with the embodiments of the disclosed, invention;

FIG. 2 is simplified example of a distributed ledger in accordance with at least one embodiment of the invention;

FIG. 3 is a block diagram depicting an example blockchain environment 300, illustrating a simplified example of how a distributed ledger, or blockchain may be distributed, or replicated, on a network;

FIG. 4 is a simplified table illustrating digital asset exchange in accordance with at least one embodiment of the disclosed invention;

FIG. 5 is an example computing/networking environment of the disclosed invention;

FIG. 6 is an example of a generic blockchain message;

FIG. 7 is an example multi-level transaction of the disclosed invention; and

FIG. 8 is a flow diagram showing concerning the disclosed invention;

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations arc known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

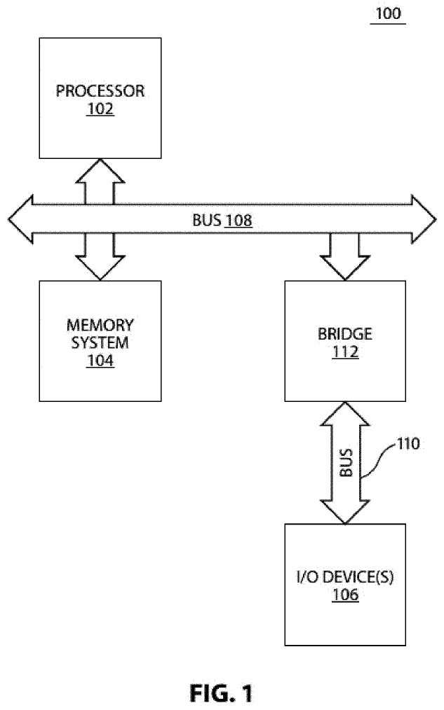

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can be implemented in a variety of ways and, may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in, connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that, the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

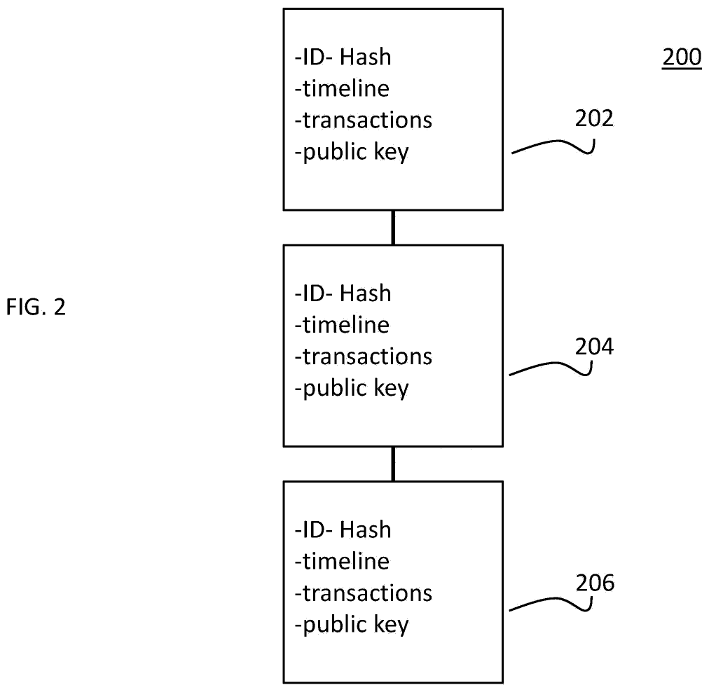

As illustrated in FIG. 2, blockchain 200 is an illustrative example in accordance with at least one embodiment of the invention. Blockchain 200 illustrates a simplified blockchain having 3 blocks, 202, 204, and 206. Block 202 is the first block and is therefore considered to be the genesis block. Each block may include certain information, such as an identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. Hash values may be combined into a Merkle tree. The linked blocks therefore form a chain where each link, or block, in the chain uniquely identifies a previous link, or block, by including the hash or the prior link, or block.

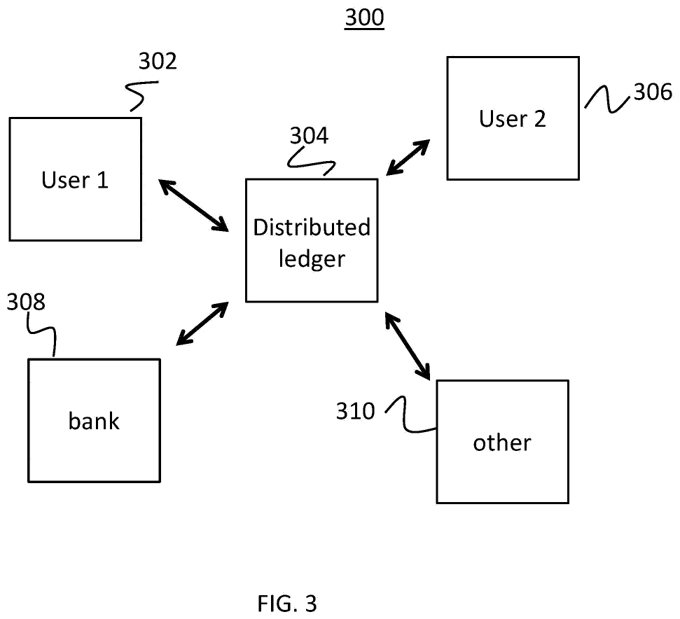

FIG. 3 is a block diagram depicting an example blockchain environment 300, illustrating a simplified example of how a distributed ledger, or blockchain (such as blockchain 200) may be distributed, or replicated, on a network. Environment 300 may include a first user 302, a second user 304, another entity, such as a bank 308, and another third party entity 310 privy to the blockchain 306. The first/second user may be a buyer or seller, based on the transaction. Entities may include, but are not limited to, consumers, bankers, merchants, and investors. Blockchain 306 may be replicated in an agreed-upon manner or in real-time (e.g., after each transaction).

Liquidity Transfer of assets in accordance with one or more embodiments of the disclosed invention will now be described. Typically on an exchange, such as a stock market exchange or the like, assets may be traded. These assets may include, but certainly are not limited to, securities, commodities, derivatives, currencies, crypto-currencies, asset-backed tokens, and other financial instruments, such as tokenized assets, futures/options/swaps, or the like. Typically, exchanges provide companies and governments, among others, a platform to sell and exchange assets, or securities, to the public.

The disclosed invention is directed towards the improvement of liquidity of digital assets on an exchange by reducing so-called leg risk. The disclosed can be used in any context where there is a transfer of at least one item for a set quantity of another item without a reference to a third item, such as the US dollar. While the disclosed does apply to digital assets, it may also apply to other assets as well, such as the context of foreign currency pairs. For example, we have a trade which is a transfer of 1 Euro for 125 Yen, without any reference to a third currency to price each of these two currencies (unlike the below mentioned stock example where stocks are priced in USD). Leg risk occurs on an exchange when an entity, such as a trader on the exchange, wants to perform a certain action (e.g., buy shares of a certain asset) but cannot complete or perform all of the actions and is left with a partial list of the actions completed, leaving the trader at a disadvantage. Failure to complete an action occurs, for example, when the price of some set of assets for which the actions were not successfully completed moves higher or lower than the price the trader desires. The disclosed provides a process whereby market orders may be aggregated in such a manner so as to minimize or eliminate this leg risk.

To illustrate a simplified example, consider an example on the U.S. Stock Exchange. The trader wants to sell 5 shares of Google® stock for $1200/each and buy 30 shares of Apple® stock for $200 each. In this example, the price of the asset is linked, to a stable currency, such as the U.S. dollar.

In this example, this means the trader can take 5 shares of Google®, sell it and get $6000, then take that $6000 and buy 30 shares of Apple®.

Currently, if the trader wants to exchange 5 shares of Google® for 30 shares of Apple®, two transactions must be executed:

1. Sell 5 shares of Google® and get $6000

2. Buy 30 shares of Apple® using that $6000

In this two-step process, the price of Apple® shares may fluctuate and potentially go up. Then the traders must decide whether to get fewer shares of Apple®, keep the cash, or buy back into Google®. If they want to turn around and convert that money back into Google® stock, there is a chance that Google® price went up as well.

In a further embodiment of the disclosed invention, leg risk is minimized utilizing a trading platform in the digital assets space. Digital assets, such as cryptocurrencies, may include, but are certainly not limited to. Bitcoin (BTC), Ethereum (ETH), Litecoin (LTC), or the like. Digital assets may fluctuate in price and all have their own independent value decided by the marketplace in real time. An algorithm is provided to enable the marketplace pricing and trade structure. The algorithm allows for trading of the aforementioned assets when there is no reference currency present. The prices used as the value for any given asset product is a product itself. The product itself is traded with its price being changed in real time.

Leg risk is very commonly known phenomenon. One more subtle thing that is missing, that being there is no way for the customer to express their true intention when they are forced to execute multiple transactions to achieve their objective. This missing information about the customer intent, when captured can improve prices and liquidity.

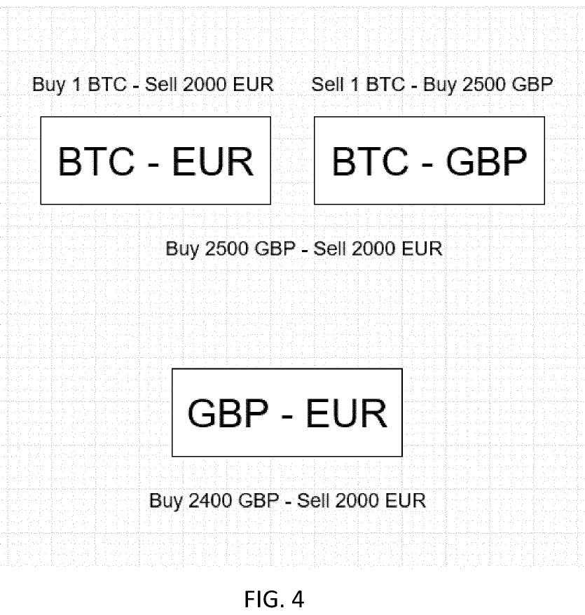

The situation becomes even more precarious when more than two traders and more than two digital assets or currencies are involved. The disclosed asset exchange platform enables the liquid transfer of assets with minimal leg risk by utilizing one or more crypto-currencies, tokenized assets, or the like as mentioned herein and above. In view of FIG. 4, an example, which should not be considered limiting, is shown. In this example, a user provides an intention to exchange EUR for GBP. The user may be shown a conversion rate, or exchange rate by the system in real time based on market fluctuations. In this example, the user deposits 2000 EUR and receives 2500 GBP. In this example the platform, outside the user's view, purchases, or converts, the 2000 EUR into a cryptocurrency, such as BTC. The amount of BTC is then used to purchase GBP. This amount of GBP is then delivered to the user. In this example, for simplicity reasons, 1 BTC 2000 EUR=2500 GBP. It is understood that these rates fluctuate over time. Further, the platform is not limited to a single crypto currency. Based on market rates, the best crypto currency, or token, may be utilized based on competitive exchange rates. Further, the disclosed platform is not limited to crypto currencies, but may also utilize tokenized assets, such as gold, oil, gas, or the like.

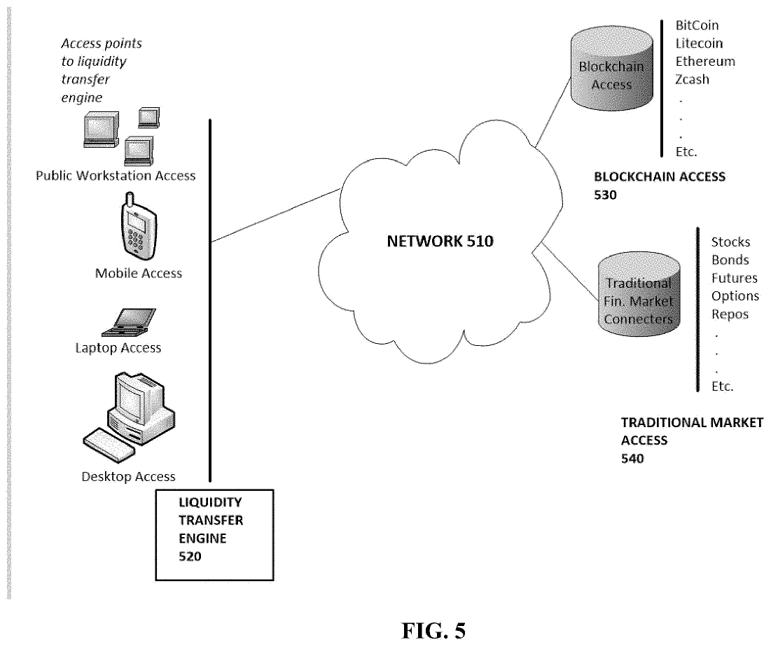

In further elaboration of the invention at hand, FIG. 5 illustrates an example computing and networking environment which the embodiment may transact and operate. As shown in FIG. 5, LIQUIDITY TRANSFER ENGINE 520 may allow a user of the invention multiple access points to such engine, for example, possibly through a mobile device, laptop, desktop, among other access points. The devices shown in the diagram is just an example and is not limiting.

Also shown in FIG. 5, NETWORK 510 allows the LIQUIDITY TRANSFER ENGINE 520 to connect to a blockchain network and also traditional financial market networks. As shown in BLOCKCHAIN ACCESS 530, the LIQUIDITY TRANSFER ENGINE 520 may gain access to blockchain currencies such as Bitcoin, LiteCoin, among other blockchain currencies. As shown in TRADITIONAL MARKET ACCESS 540, the LIQUIDITY TRANSFER ENGINE 520 may gain access to the traditional financial to potentially buy and sell securities and/or other types financial vehicles such as stocks, bonds, options, foreign currencies, and repurchase agreements.

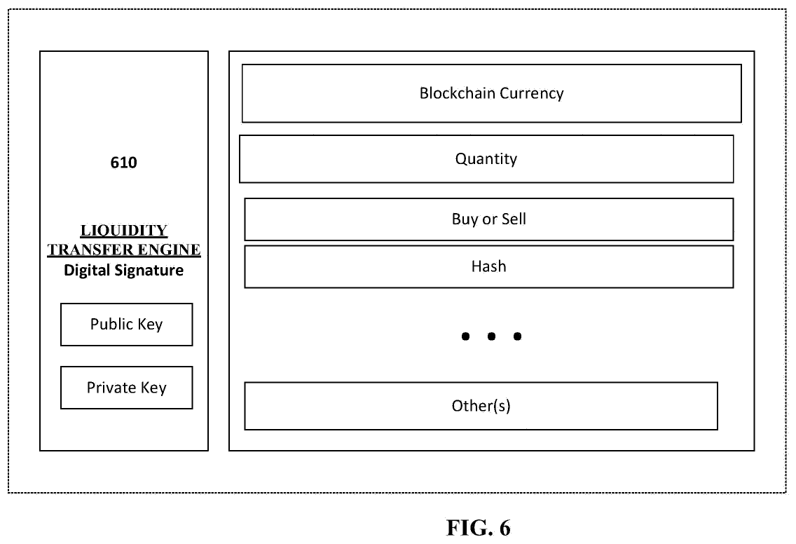

FIG. 6 is a generic blockchain block which the invention may use purchase, or sell, a blockchain currency. At 610, it is shown that the LIQUIDITY TRANSFER ENGINE may utilize a public and private key to create a digital signature. Which with the “Hash” shown in FIG. 6 may create a unique block which is immutable and trustworthy. As illustrated in FIG. 6, there may be fields in the block for blockchain Currency which identifies what exact blockchain currency is being purchased/sold (e.g., Zcash). Also fields for Quantity (how much of the currency) and Buy or Sell (is it a buy or sell?) are shown to establish those variable which would be used by the blockchain to effect the transaction.

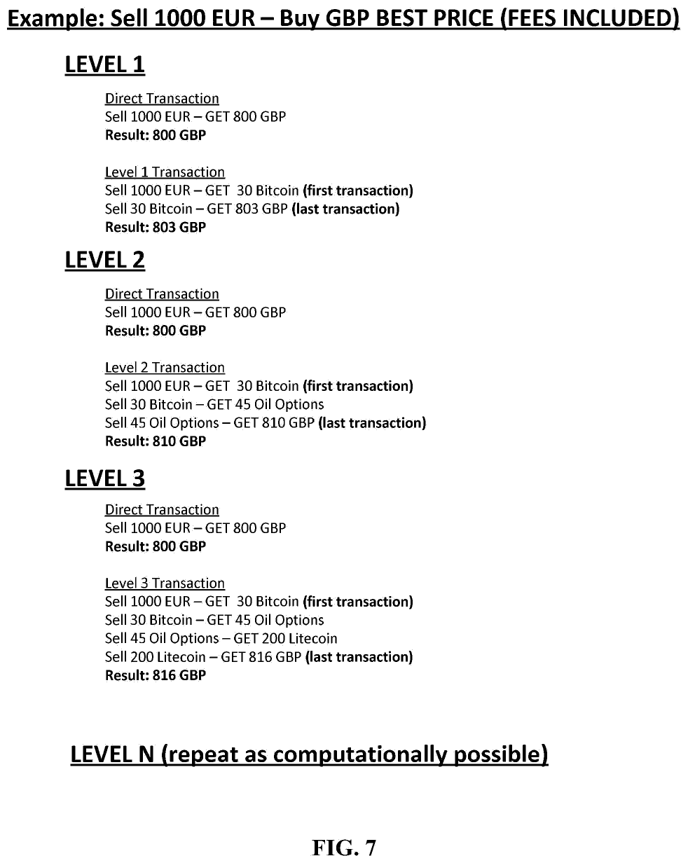

FIG. 7 is an example of how the LIQUIDITY TRANSFER ENGINE 520 may effect a financial transaction to reduce legging risk. As illustrated in FIG. 7, the example involves a user who wants to sell 1000 EUR and use that sale to get the best price for GBP. FIG. 7 shows that in LEVEL 1 a direct sale and purchase would result in a user receiving 800 GBP. FIG. 7 also shows that in LEVEL 1, there may be 1 intermediary market purchase before the ending purchase of GBP where the LIQUIDITY TRANSFER ENGINE 520 first calculates that a user may obtain 30 Bitcoin for 1000 EUR. After that the LIQUIDITY TRANSFER ENGINE 520 determines that it can sell the 30 Bitcoin and purchase 803 GBP. Thus the user would obtain 803 GBP instead of 800 GBP.

FIG. 7 shows that in LEVEL 2 a direct sale and purchase would result in a user receiving 800 GBP. FIG. 7 also shows that in LEVEL 2, there may be 2 intermediary market purchases before the ending purchase of GBP where the LIQUIDITY TRANSFER ENGINE 520 first calculates that a user may obtain 30 Bitcoin for 1000 EUR. After that the LIQUIDITY TRANSFER ENGINE 520 determines that it can sell the 30 Bitcoin and purchase 45 Oil Options. After that the LIQUIDITY TRANSFER ENGINE 520 determines that it can sell the 45 Oil Options and purchase 810 GBP. Thus the user would obtain 810 GBP instead of 800 GBP. Which in this example is a better trade than at LEVEL 1.

FIG. 7 shows that in LEVEL 3 a direct sale and purchase would result in a user receiving 800 GBP. FIG. 7 also shows that in LEVEL 3, there may be 3 intermediary market purchases before the ending purchase of GBP where the LIQUIDITY TRANSFER ENGINE 520 first calculates that a user may obtain 30 Bitcoin for 1000 EUR. After that the LIQUIDITY TRANSFER ENGINE 520 determines that it can sell the 30 Bitcoin and purchase 45 Oil Options. After that the LIQUIDITY TRANSFER ENGINE 520 determines that it can sell the 45 Oil Options and purchase 200 Litecoin currency. After that the LIQUIDITY TRANSFER ENGINE 520 determines that it can sell the 200 Litecoin currency and purchase 816 GBP. Thus the user would obtain 816 GBP instead of 800 GBP. Which in this example is a better trade than at LEVEL 1 and LEVEL 2.

FIG. 7 shows that in LEVEL N, as many levels of transactions may be calculated as feasibly possible by the existing computing system but also should take into account the speed and complexity of the outside networks such as the blockchain networks referenced in BLOCKCHAIN ACCESS 530 and the traditional financial market networks referenced in TRADITIONAL MARKET ACCESS 540. Thus, if there is potential lag in computation due to such constraints, then the LIQUIDITY TRANSFER ENGINE 520 may only calculate 3 levels of transactions instead of 6.

As shown in FIG. 7, there are initial, intermediate, and final prices of the financial instruments that are bought and/or traded, potentially in many levels. The LIQUIDITY TRANSFER ENGINE 520 also incorporates any transaction fees (buying/selling fees) which are due per transaction and includes such fees in the resulting transaction value, like the 810 GBP result in LEVEL 2, where the 810 GBP is after all fees are brought to bear. This should give the user of the invention “piece of mind” when using it and also save such user in additional calculations of determining profit.

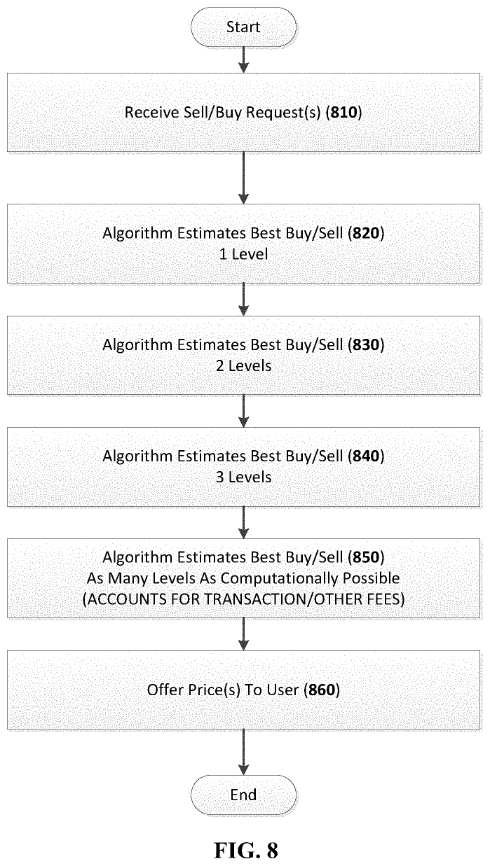

FIG. 8 is a flow diagram depicting how the LIQUIDITY TRANSFER ENGINE 520 may process each buy/sell request, to result in less “leg” risk. As shown in block 810, LIQUIDITY TRANSFER ENGINE 520 receives requests from a user to perform multiple financial transactions, whether with blockchain currencies or any other blockchain financial vehicle along with traditional financial market vehicles likes stocks/bonds.

Block 820 shows that LIQUIDITY TRANSFER ENGINE 520 may estimate purchases and sales of financial vehicles with 1 intermediary transaction before the resulting transaction. Block 830 shows that LIQUIDITY TRANSFER ENGINE 520 may estimate purchases and sales of financial vehicles with 2 intermediary transactions before the resulting transaction. Block 840 shows that LIQUIDITY TRANSFER ENGINE 520 may estimate purchases and sales of financial vehicles with 3 intermediary transactions before the resulting transaction. The details of how this calculation may be accomplished are in FIG. 7,

FIG. 8, block 850, also establishes that LIQUIDITY TRANSFER ENGINE 520 may decide to perform as many levels of intermediary purchase/sale estimations as computationally possible. This involves not only the hardware/software limitations of LIQUIDITY TRANSFER ENGINE 520, but lag and other performance factors which also involve the blockchain network, normal financial market networks, and any other networks or technology which may affect performance of the LIQUIDITY TRANSFER ENGINE 520's calculation. Moreover, as each transaction may result in fees which are also taken into account by the LIQUIDITY TRANSFER ENGINE 520 when deciding how many intermediary levels of transactions should happen. Finally, block 860, shows that the requesting user may be notified of the resulting prices and any other output from the calculation performed by LIQUIDITY TRANSFER ENGINE 520.

It is appreciated that exemplary computing system 100 and the sample computing/networking environment in FIG. 5 is merely illustrative of a computing and networking environments in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A method for providing the liquid transfer of assets, with at least one computing device, the method comprising:
receiving, at an access point at the computing device, a request to sell financial assets and/or buy financial assets;
calculating, by a processor, through a liquidity transfer engine, a number of intermediary asset purchases and/or sales which can be calculated with the computing resources available;
calculating, by the processor, through the liquidity transfer engine, the buying and selling prices related to each number of the intermediary purchases and/or sales initially calculated;
determining, by the processor, through the liquidity transfer engine, an optimum number of intermediary purchases and sales which provide the highest return for the request to sell financial assets and/or buy financial assets; and
notify, by the processor, through the liquidity transfer engine, the requester of such request to sell financial assets and/or buy financial assets, the suggested optimum number of financial asset purchases and/or sales with the details of each transaction including price.

2. The method of claim 1, wherein the financial assets may be a blockchain financial asset or normal financial market asset such as stocks, bonds, foreign currencies, and options or any other financial asset of monetary value.

3. The method of claim 2, wherein the blockchain financial asset may be requested by the liquidity transfer engine by using a blockchain block with details of the blockchain financial asset which is in turn published to the blockchain for verification.

4. The method of claim 2, wherein the financial market asset may be requested by the liquidity transfer engine by using a traditional market access tool like a Bloomberg terminal, or the like.

5. A system for providing the liquid transfer of assets, with at least one computing device, the system comprising:
a memory,
a processor communicatively coupled to the memory, the memory including executable instructions that upon execution by the processor cause the system to:
receive, a request to sell financial assets and/or buy financial assets;
calculate, through a liquidity transfer engine, a number of intermediary asset purchases and/or sales which can be calculated with the computing resources available to the processor;
calculate, through the liquidity transfer engine, the buying and selling prices related to each number of the intermediary purchases and/or sales initially calculated;
determine, through the liquidity transfer engine, the number of intermediary purchases and/or sales which provide the highest return for the request to sell financial assets and buy financial assets; and
notify, through the liquidity transfer engine, the requester of such request to sell financial assets and/or buy financial assets, the suggested optimum number of financial asset purchases and sales with details of each transaction including price.

6. The system of claim 5, wherein the financial assets may be a blockchain financial asset or normal financial market asset such as stocks, bonds, foreign currencies, and options or any other financial asset of monetary value.

7. The system of claim 6, wherein the blockchain financial asset may be requested by the liquidity transfer engine by using a blockchain block with details of the blockchain financial asset which is in turn published to the blockchain for verification.

8. The system of claim 6, wherein the financial market asset may be requested by the liquidity transfer engine by using a traditional market access tool like a Bloomberg terminal, or the like.

9. A non-transitory computer-readable storage medium having contents adapted to cause a programmed computer system to perform the operations of providing the liquid transfer of assets, with at least one computing device, comprising:
receiving, at an access point at the computing device, a request to sell financial assets and/or buy financial assets;
calculating, by a processor, through a liquidity transfer engine, a number of intermediary asset purchases and/or sales which can be calculated with the computing resources available;
calculating, by the processor, through the liquidity transfer engine, the purchasing and/or selling prices related to each number of the intermediary purchases and/or sales initially calculated;
determining, by the processor, through the liquidity transfer engine, an optimum number of intermediary purchases and sales which provide the highest return for the request to sell financial assets and/or buy financial assets; and
notify, by the processor, through the liquidity transfer engine, the requester of such request to sell financial assets and/or buy financial assets, the suggested optimum number of financial asset purchases and sales with details of each transaction including price.

10. The non-transitory computer-readable storage medium of claim 9, wherein the financial assets may be a blockchain financial asset or normal financial market asset such as stocks, bonds, foreign currencies, and options or any other financial asset of monetary value.

11. The non-transitory computer-readable storage medium of claim 10, wherein the blockchain financial asset may be requested by the liquidity transfer engine by using a blockchain block with details of the blockchain financial asset which is in turn published to the blockchain for verification.

12. The non-transitory computer-readable storage medium of claim 10, wherein the financial market asset may be requested by the liquidity transfer engine by using a traditional market access tool like a Bloomberg terminal, or the like.
